(19) United States
(12) Patent Application Publication
(10) Pub. No.: US 2016/0380466 A1
(43) Pub. Date: Dec. 29, 2016

(54) DEVICE DEPENDENT MAXIMUM COIL CURRENT

(71) Applicant: Intel Corporation, Santa Clara, CA (US)

(72) Inventors: Songnan Yang, San Jose, CA (US); John M. Roman, Hillsboro, OR (US); Zhen Yao, San Jose, CA (US); Robert Paxman, Hillsboro, OR (US); Suraj Sindia, Hillsboro, OR (US)

(21) Appl. No.: 14/859,707

(22) Filed: Sep. 21, 2015

Related U.S. Application Data
(60) Provisional application No. 62/185,301, filed on Jun. 26, 2015.

(51) Int. Cl. H02J 7/02; H02J 7/00; H04W 76/02; H04W 4/00; H04W 8/00

(52) U.S. Cl. CPC H02J 7/025; H04W 4/008; H04W 8/005; H04W 76/021; H02J 7/0036; H02J 2007/0096

(57) ABSTRACT

This disclosure describes methods, apparatus, and systems related to a maximum coil current system. A device may determine a presence of a first device placed on a charging area of the device, the charging area including a power transmitting surface. The device may establish a connection with the first device using one or more communication protocol. The device may identify device information associated with the first device using the established connection. The device may determine a maximum charging current for the first device based at least in part on the device information.

### CROSS-REFERENCE TO RELATED APPLICATIONS

This application claims the benefit of U.S. Provisional Application No. 62/111,538 filed Feb. 3, 2015, the disclosure of which is incorporated herein by reference as if set forth in full.

### TECHNICAL FIELD

This disclosure generally relates to systems and methods for wireless charging stations, more particularly, to coil currents.

### BACKGROUND

Wireless charging or inductive charging uses a magnetic field to transfer energy between devices. Wireless charging may be implemented at a charging station. Energy is sent from one device to another device through an inductive coupling. The inductive coupling is used to charge batteries or run a device. The Alliance for Wireless Power (A4WP) was formed to create industry standard to deliver power through non-radiative, near field, magnetic resonance from a power transmitting unit (PTU) to a power receiving unit (PRU). A user's exposure to radio frequency (RF) waves may be evaluated using specific absorption rate (SAR).

### BRIEF DESCRIPTION OF THE DRAWINGS

FIG. 1(a) depicts a network diagram illustrating an example network environment of an illustrative maximum coil current system, in accordance with one or more example embodiments of the present disclosure.

FIG. 1(b) depicts illustrative current limits for various user device categories and on specific absorption rate (SAR) limits.

FIGS. 2(a)-(c) illustrate an example SAR simulation depicting a user exposure to radio frequency (RF) waves with category 1-3 user devices, in accordance with one or more example embodiments of the present disclosure.

FIGS. 3(a)-(b) illustrate SAR simulation setup with representative category 5 devices, in accordance with one or more example embodiments of the present disclosure.

FIG. 3(c) illustrates magnetic field with or without representative power receiving unit (PRU) present, in accordance with one or more example embodiments of the present disclosure.

FIG. 4 illustrates maximum coil current system flow chart, in accordance with one or more example embodiments of the present disclosure.

FIG. 5(a) depicts a flow diagram of an illustrative process for an illustrative maximum coil current system, in accordance with one or more embodiments of the disclosure.

FIG. 5(b) depicts a flow diagram of an illustrative process for an illustrative maximum coil current system, in accordance with one or more embodiments of the disclosure.

FIG. 6 illustrates a functional diagram of an example communication station that may be suitable for use as a user device, in accordance with one or more example embodiments of the disclosure.

FIG. 7 is a block diagram of an example machine upon which any of one or more techniques (e.g., methods) may be performed, in accordance with one or more embodiments of the disclosure.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

A power transmitting unit (PTU) may transmit power wirelessly to charge a power receiving unit (PRU). The A4WP specification (e.g., A4WP Rezence™ BSS V1.2, published Jul. 28, 2014) provides guidelines for charging various PRUs, such as smartphone. However, with the advancement in computing devices, other devices, such as tablets, phablets, laptops, may also require wireless charging. The size of these devices may result in increased power delivery requirements. Accordingly, radio frequency (RF) safety may be impacted with the increased power delivery. Compliance to RF exposure requirement may be demonstrated through numeric modeling of specific absorption rate (SAR). Regulatory bodies, such as the Federal Communications Commission (FCC) in the United States, established upper limits of SAR that a device may need to comply with in the measure of watts per kilogram (W/kg). In general, SAR is higher when a human body is exposed to higher magnetic field, or a greater portion of the human body is in overlap with the wireless charging active area.

Higher power devices with large form factors (such as laptop PCs, tablets, etc.) may require higher current as compared to a small device. When the higher power devices are presented to a wireless charging field of a PTU, a higher current is needed in order to be driven through the power transmitting unit (PTU) coil, in order to compensate for the magnetic field cancelling effect due to the Eddy current induced on the device chassis, and maintain a sufficient magnetic field for power transfer. This higher current defined by the higher power device may determine the PTU current requirement (e.g., ITX_MAX) of the PTU coil when it is used to wirelessly charge A4WP compliant PRUs, even though, for smaller devices, such as smartphones, this ITX_MAX may be greater than necessary.

The SAR is low for large form factor PRU devices, such as laptops and tablets, as the PTU may be designed such that a large PTU active area may be covered by the PRU device during power transfer, minimizing the user's exposure to the magnetic field generated by the PTU on the charging surface. However, for smaller devices such as smartphones and wearables, which may be placed on the same size PTU, there may be enough area for a user's arm for example to be exposed to the charging field while the smaller device is being charged. This exposure condition coupled with higher than necessary current could lead to SAR values higher than the compliance limit, without user restrictions and costly chassis designs.

Example embodiments of the present disclosure relate to systems, methods, and devices for introducing a maximum coil current limit for RF safety compliance, and a method of setting a PTU maximum coil current limit dynamically based on a PRU device category information, with the goal of mitigating SAR regulatory compliance issues for high power, larger active area PTUs.

In one embodiment, a PTU having a transmitting coil may define a maximum coil current based on the user device (e.g., PRU) being charged. At that maximum coil current, a user's RF exposure to a charging field generated by PTU may not exceed the SAR limit. However, depending on the size of the user device and the chassis material, the impact to the coupling when it is presented to the transmitting coil may be different. As a result, the current required to properly transfer power is larger than the current required to charge a small device. This may be attributable to the chassis material because the device may contain many metal components, which may cause the generation of Eddy current that may cancel out the current coupling between the PRU and the PTU. In that case, the current required becomes higher.

In one embodiment, a maximum coil current limit may be defined to support multiple PRUs with varying sizes, such as, smartphone, phablets, tablets, laptops. However, in order for a maximum coil current to be employed, it may not be set to a high value that could damage small devices or exceed the RF exposure limits. For example, if the maximum coil current limit is set such that it may charge a laptop but a small device (e.g., a wearable device) is being charged instead of the larger device, the PTU may continue to raise the current up to that maximum value in some cases, which may create RF exposure conditions that exceed the SAR limit. If the small device enters a very low coupling position, for example, being placed at the edge of the PTU, or outside the charging area of the PTU, the PTU may continue to charge the small device by increasing the current. However, because of the increased current, and under unrestricted user conditions, the RF levels may exceed SAR limits imposed by regulatory bodies such as the FCC in the United States. In the case of placing a large device (e.g., a laptop) on the PTU, the exposure or the maximum current limit may not be an issue because in that case the large device may cover a large portion of the charging area of the PTU. In that case, the user may not be fully exposed to the charging magnetic field and hence the SAR values may not exceed regulatory limits. In that case, it may be required that the current is increased to a level that may be enough to charge the large device. In one embodiment, a maximum coil current may be defined based on the PRU such that the current does not increase, limiting the magnetic field to a point where the SAR limits are not exceeded.

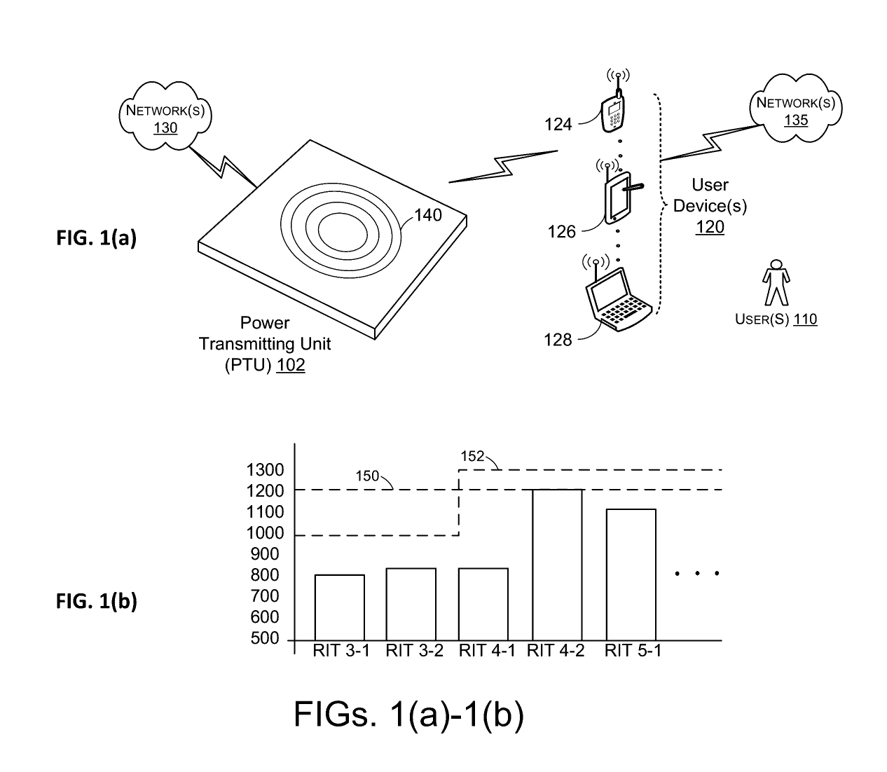

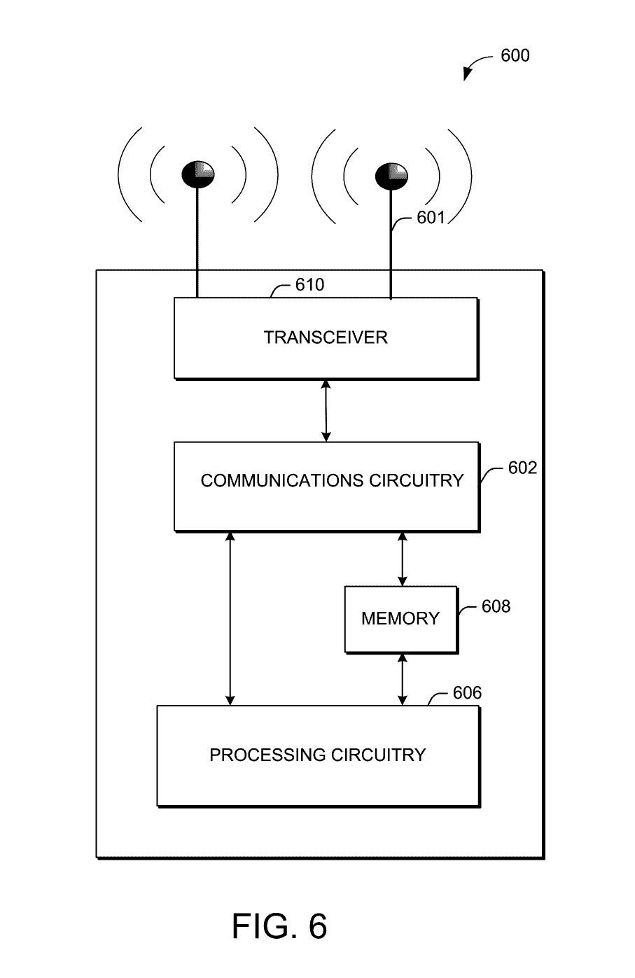

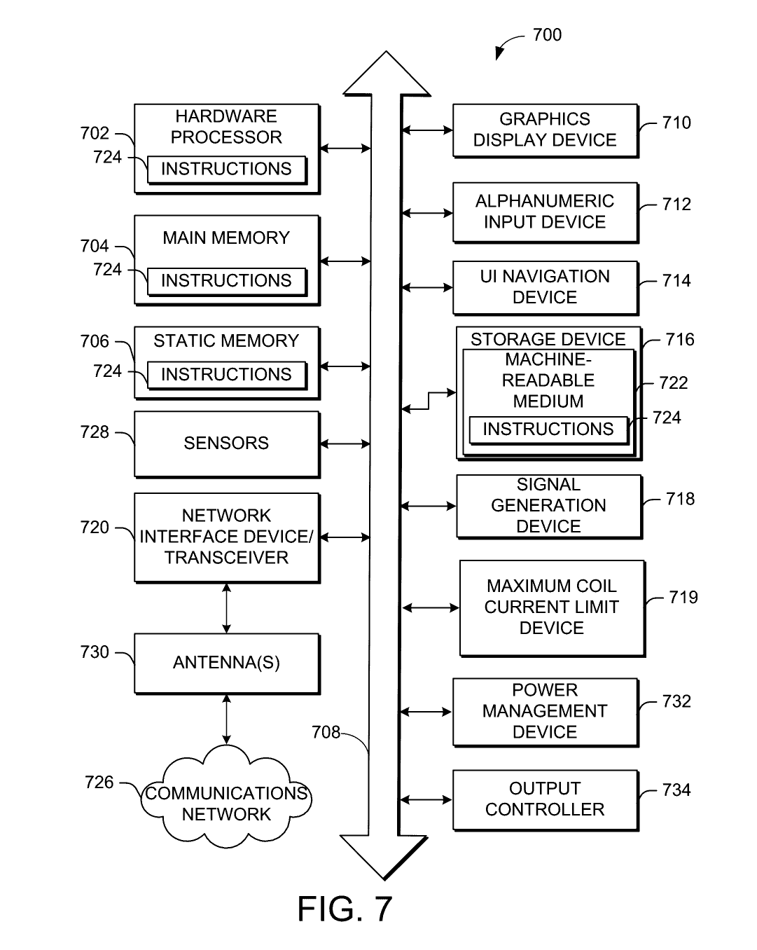

FIG. 1(a) depicts a network diagram illustrating an example network environment of an illustrative maximum coil current system, in accordance with one or more example embodiments of the present disclosure, which may include one or more user devices 120 and a wireless power transmitting device (PTU) 102. The one or more user devices 120 may be power receiving units (PRUs) operable by one or more user(s) 110. The user device(s) 120 (e.g., 124, 126, or 128) may include any suitable processor-driven user device including, but not limited to, a desktop user device, a laptop user device, a server, a router, a switch, an access point, a smartphone, a tablet, wearable wireless device (e.g., bracelet, watch, glasses, ring, etc.) and so forth. While FIG. 1(a) shows PRUs including laptop 128 and smart devices 124 and 126, the disclosed principles are not limited thereto and may include any device capable of wireless charging. In some embodiments, the user devices 120 and PTU 102 may include one or more computer systems similar to that of the functional diagram of FIG. 6 and/or the example machine/system of FIG. 7.

Any of the user device(s) 120 (e.g., user devices 124, 126, 128), and PTU 102 may be configured to communicate with each other via one or more communications network 130 and/or 135 wirelessly or wired. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128), and PTU 102 may include one or more communications antennae. Communications antenna may be any suitable type of antenna corresponding to the communications protocols used by the user device(s) 120 (e.g., user devices 124, 124 and 128), and PTU 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user devices 120.

Any of the user devices 120 (e.g., user devices 124, 126, 128), and PTU 102 may include any suitable radio and/or transceiver for transmitting and/or receiving radio frequency (RF) signals in the bandwidth and/or channels corresponding to the communications protocols utilized by any of the user device(s) 120 and PTU 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1(a), PTU 102 may include a transmitting coil (e.g., coil 140), and the PRUs (e.g., user devices 120) may include a receiving coil. Energy may be transmitted from the transmitting coil to the receiving coil by, for example, electromagnetic induction between the two coils. This may cause the transmission of charging power from the PTU to the PRU in response to determining that the PRU is located within the charging area. The PTU may communicate with a PRU to receive information, such as, identification information, power received, power needed, location, etc.

A PRU (e.g., user device(s) 120) may be divided into multiple categories, primarily by power requirement. The categories of PRU may be parameterized by the maximum power delivered out of the PRU resonator. For example, category 1 may be directed to lower power applications (e.g., Bluetooth headsets). Category 2 may be directed to devices with power output of about 3.5 W. Category 3 devices may be directed to devices with power output of about 6.5 W. Categories 4, 5 and 6 may be directed to higher-power applications (e.g., tablets, netbooks and laptops) and may have a power output of about 37.5 W.

In one embodiment, PRU devices may communicate their category information (such as RIT 3-1, RIT 3-2, RIT 4-1, RIT 4-2, RIT 5-1) to the PTU 102 through Bluetooth or an appropriate communication control channel enabled via Wi-Fi, GSM, NFC, or the like. The category information communicated may enable the PTU to load the coil with the correspondingly adequate ITX_MAX current.

In one embodiment, during PRU advertisement through, for example, Bluetooth Low Energy (BLE) radio, in-band modulation, or the like, the PRU category information may be transferred to the PTU as static PRU parameters. It is understood that although advertisement is done through BLE, in-band modulation, any other communication protocols that may be used for communicating between two devices may be used.

FIG. 1(b) depicts illustrative current limits for various user device categories and on specific absorption rate (SAR) limits.

A requirement of the Alliance for Wireless Power (A4WP) specification is that the PRU's rectified voltage (VRECT) should exceed its minimum rectified voltage (VRECT_MIN) if the current of the transmitter coil (ITX_COIL) is greater than or equal to the maximum current of the transmitter coil (ITX_MAX). Further, for a PTU resonator, the maximum allowed current (ITX_MAX) may be set such that all the resonator interface testers (RITs) meet their corresponding Vset or Vmin condition for multiple PRU charging and single PRU charging respectively. An RIT is a device that may emulate one or more PRUs based on their category for testing purposes. Under such requirements, if one of the category devices or RIT requires higher coil current to meet Vset or Vmin condition, the overall ITX_MAX of the PTU resonator may be set to a higher value. In addition, in some cases, if the PTU has large active area and the device under charge has small form factor that does not completely cover the PTU active area, a higher ITX_MAX current may not be necessary.

In one embodiment, a category specific ITX_MAX requirement (e.g., ITX_SAR_MAX) may be implemented to allow different and more appropriate MAX coil current setting per category of PRU device that the PTU may be required to support. This approach may enable the PTU to operate within a lower ITX_MAX limit when, for example, a category 3 or lower device is the only device being charged on the PTU's active area. The ITX_SAR_MAX may be set to a low enough value that avoid exceeding the SAR compliance limit while still satisfying the A4WP compliance requirements in PTU currents.

As the A4WP moves toward higher category device support, the increase in device chassis size going to category 4 and above may require higher coil current to maintain the same magnetic field (as lower category devices may need) from the PTU in order to reach set voltage on the PRU. For example, looking at FIG. 1(b), a category 4 PTU coil (e.g., 210×210 mm active area size @ 9 mm separation), the ITX requirement for each of the category's RITs to reach Vset is shown. As can be seen, moving to category 4 and 5 devices, the larger chassis may cancel significant part of the magnetic field applied by the PTU coil, such that a higher PTU coil current may be required for the PRU to reach Vset. For example, RIT 4-1 may be constructed to emulate a 10 inch tablet (e.g., iPad), which may have a metal chassis and may cause the most significant Eddy current, which in turn may require the highest current from PTU coil to reach Vmin. The ITX_MAX 150 of the PTU coil may need to be set at a value that is greater than the highest each category RIT would require to reach Vset (e.g., >1200 mArms).

However, when the SAR is evaluated for the same PTU coil through numerical modeling, the maximum current that may allow PTU to stay regulatory compliant when charging representative implementation of a particular device category is shown as SAR Limit 152 in FIG. 1(b). As can be seen, if a category 3 device is being charged by the large PTU coil, and the current is driven to ITX_MAX 150, then it may not be able to meet SAR compliance.

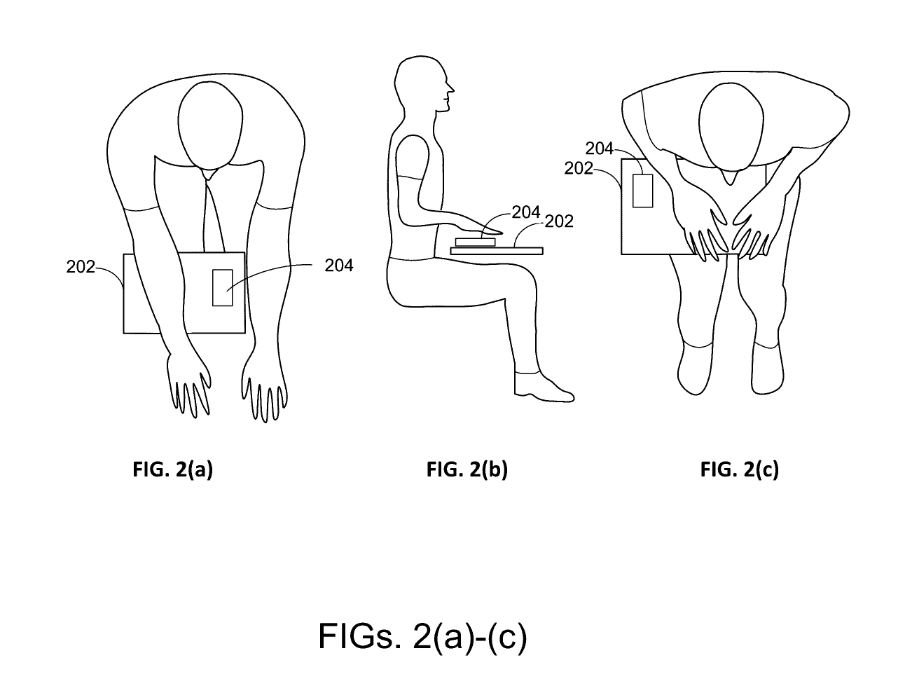

FIGS. 2(a)-(c) illustrate an example SAR simulation depicting a user exposure to radio frequency (RF) waves with category 1-3 user devices, in accordance with one or more example embodiments of the present disclosure.

As can be seen, a user's forearm (FIG. 2 (a)), thigh and torso (FIG. 2 (b)) and hand (FIG. 2(c)), may be exposed to a PTU 202 coil while charging a small device (e.g., user device 204). The SAR may be simulated in order to determine the separation required for the RF exposure to stay compliant. However, in the case of forearm exposure, the same magnetic field used to charge user device 204 may be applied to the human body in overlap with the active area and induce tissue heating (e.g., SAR). In one embodiment, the mitigation method may be to reduce the current on the PTU 202 coil. The upper limit of coil current to stay compliant for device category 3 and below may be than ITX_MAX 150 (FIG. 1(b)) value determined by category 4+ devices.

In one embodiment, if the PTU is resting on a surface directly under PRU device, i.e. if there is no separation between PTU and PRU devices by a dielectric media, then following may apply. In FIG. 2 (a), a pressure sensor embedded into the PTU may trigger the PTU to establish the presence of PRU. Additionally, in FIG. 2 (a), a pressure sensor embedded into the PTU may help in identifying the category of the PRU based on the weight resting upon the PTU. For example, a wearable device (RIT 3-1) tends to be lighter than PC or notebook device (RIT 4-2).

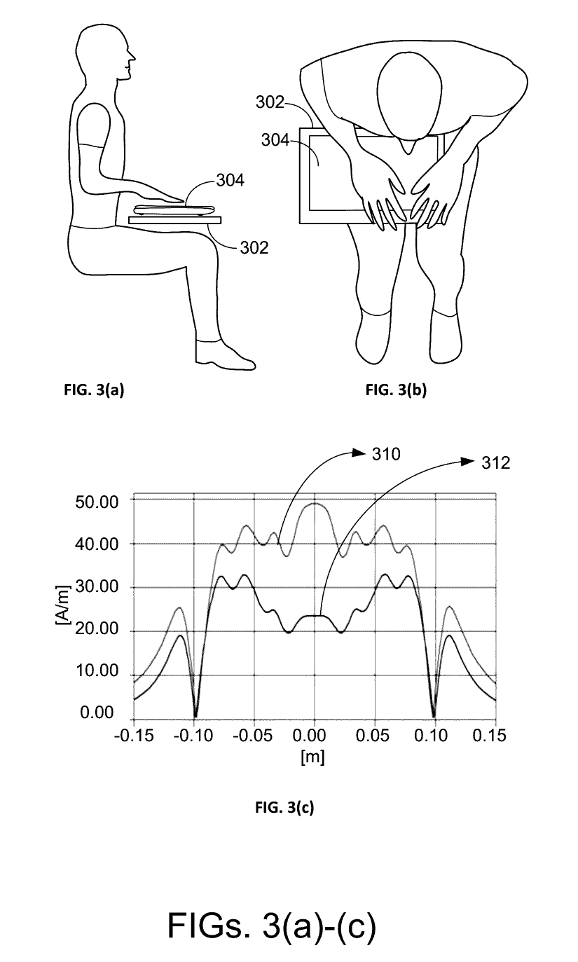

FIGS. 3(a)-(b) illustrate SAR simulation with representative category 5 devices, in accordance with one or more embodiments of the disclosure. FIG. 3(c) illustrates magnetic field with or without representative PRU present, in accordance with one or more embodiments of the disclosure.

For higher category and larger devices, such as category 5 (e.g., laptops), the SAR simulation setup may include the representative receiver device (such as PRU 304), as shown in FIGS. 3(a)-(b). Since the PRU 304 device may have a metallic chassis larger than the PTU 302 coil size, the exposure condition for hand and forearm may be minimal. Further, for thigh exposure, due to the presence of the category device with large metal chassis, the field exposed to the user's thigh may be reduced (e.g., measurement 312) as shown in FIG. 3(c) due to the Eddy current effect on the chassis, such that the current limit for SAR compliance may be higher than that of device category 3 and lower categories. Measurement 310 represents the exposure in Ampere per meter (A/m) of the conditions in FIGS. (2b) and 2(c), while measurement 312 represents the exposure in of the conditions in FIGS. 3(a) and 3(b). As can be seen in FIG. 3(c), the exposure is lower in measurement 312, where a large device is being charged on PTU 302.

In one embodiment, category specific ITX_MAX limits may be implemented, where for the lower category device, it may be defined by the SAR compliance requirement of the coil current (e.g., ITX_SAR_MAX) while for higher category (4+) in general, ITX_MAX may be defined by RAT (Resonator Acceptance Test) testing against RITs.

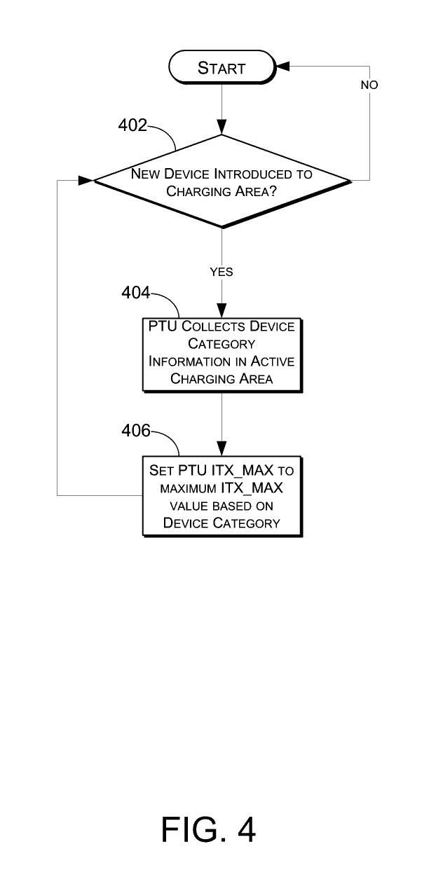

FIG. 4 illustrates a flow chart for determining an ITX_MAX setting, in accordance with one or more embodiments of the disclosure.

In one embodiment, the method of reconfiguration the ITX_MAX setting on a PTU may be achieved. The PTU may determine whether a new user device (e.g., user device(s) 120) was introduced to the charging area (e.g., step 402). If so, the PTU may collect the advertised category information of the PRUs associated with the PTU (step 404). This information may be used to determine the ITX_MAX setting (step 406). For example, during the initial handshake procedure, the PTU 102 and at least one of the user devices 120 may exchange data using one or more wireless communications protocol (e.g., BLE, NFC, Wi-Fi, in-band modulation, etc.). It is understood that in-band modulation is a technique for transmitting control signals within the same channel or frequency between two devices, for example, between a PTU and a PRU. The exchanged data may include device specific information such as the category of the user device 120. For example, if the user device 120 is a tablet, the exchanged data may provide the PTU 102 that the user device is a category 4 device. It is understood that the ITX-MAX value may be set on a per user device basis.

In another embodiment, the decision of setting new ITX_MAX value for PTU may be made based on other parameter measurable by the PTU, such as the reactance shift produced by PRU, PRU's Universally Unique Identifier (UUID) or BLE MAC address, etc. In this case, the ITX_MAX dynamic configuration may be based on user device specific information.

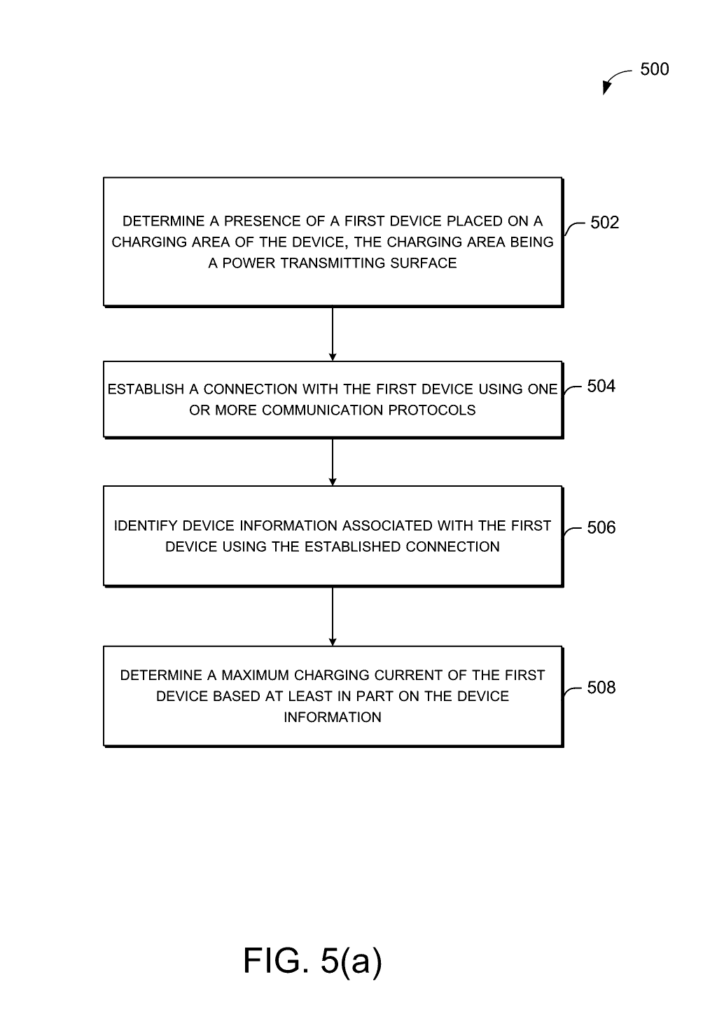

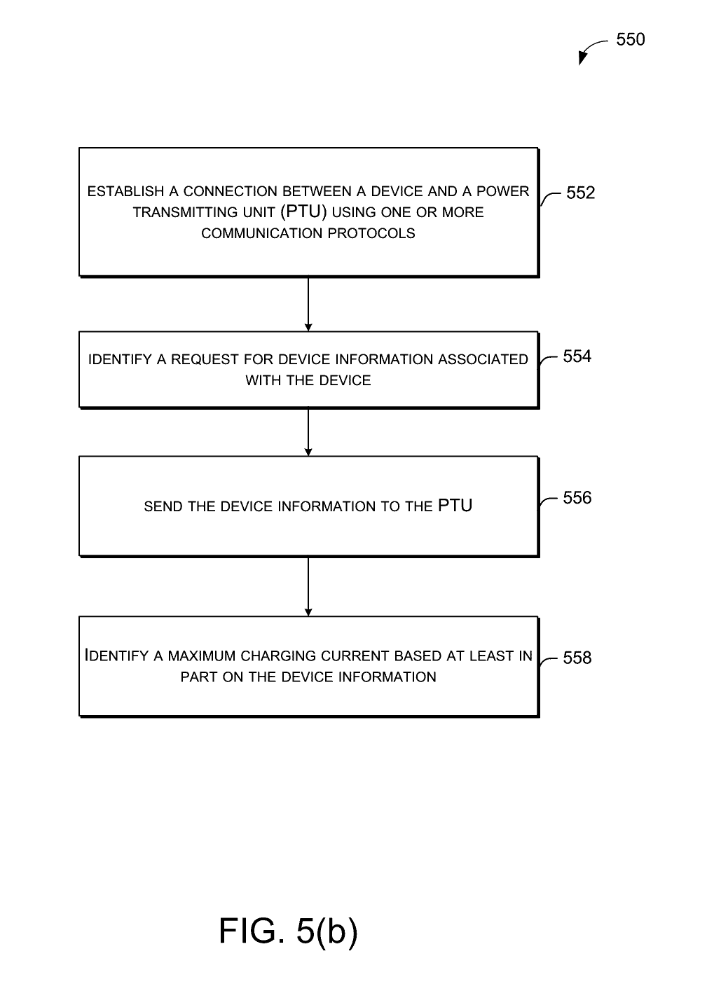

FIG. 5(a) illustrates a flow diagram of illustrative process 500 for a maximum coil current system in accordance with one or more embodiments of the disclosure.

At block 502, a PTU may determine a presence of a device, such as a power receiving unit (PRU) placed on a charging area of the PTU, the charging area including a power transmitting surface. The PRU may cover a portion of the charging area of the PTU. For example, if the device is a large device, such as a laptop, it may cover a larger portion of the charging area compared to a small device, such as a smartphone.

At block 504, the PTU may establish a connection with the first device using one or more communication protocols. Establishing a connection may include performing a handshake procedure by which the two devices (PTU and PRU) initiate communication with each other in order to establish a session, in which these devices can exchange any desired information. For example, the handshake procedure may be used for exchanging identification information between the PRU and the PTU. The one or more communication protocols include at least one of a Bluetooth Low Energy (BLE), Near Field Communication (NFC), in-band modulation, or Wi-Fi, or any other communication protocols that may be used for communicating between two devices.

At block 506, the PTU may receive and identify device information from the PRU using the established connection. The device information may include information about which category the PRU is. The category of the device is at least one of a low power output, medium power output, or a high power output. For example, the categories of PRU may be parameterized by the maximum power delivered out of the PRU resonator. For example, category 1 may be directed to lower power applications (e.g., Bluetooth headsets). Category 2 may be directed to devices with power output of about 3.5 W. Category 3 devices may be directed to devices with power output of about 6.5 W. Categories 4, 5 and 6 may be directed to higher-power applications (e.g., tablets, netbooks and laptops) and may have a power output of about 37.5 W.

At block 508, the PTU may determine a maximum charging current based at least in part on the device information. The maximum charging current may be defined based on the PRU such that the current does not increase to a point where the SAR values would be exceeded.

FIG. 5(b) illustrates a flow diagram of illustrative process 550 for a maximum coil current system in accordance with one or more embodiments of the disclosure.

At block 552, a PRU may establish a connection with a PTU using one or more communication protocols. Establishing a connection may include performing a handshake procedure for exchanging identification information between the device and the PTU. The one or more communication protocols include at least one of a Bluetooth Low Energy (BLE), Near Field Communication (NFC), in-band modulation, or Wi-Fi, or any other communication protocols that may be used for communicating between two devices.

At block 554, the PRU may identify a request for device information associated with the device. The device information includes at least in part a category of the device. The category of the device is at least one of a low power output, medium power output, or a high power output. For example, category 1 may be directed to lower power applications (e.g., Bluetooth headsets). Category 2 may be directed to devices with power output of about 3.5 W. Category 3 devices may be directed to devices with power output of about 6.5 W. Categories 4, 5 and 6 may be directed to higher-power applications (e.g., tablets, netbooks and laptops) and may have a power output of about 37.5 W.

At block 556, the PRU may send the device information to the PTU. For example, the PRU may advertise through, for example, Bluetooth Low Energy (BLE) radio, in-band modulation, the PRU category information may be transferred to the PTU as static PRU parameters. It is understood that although advertisement is done through BLE, in-band modulation, any other communication protocols that may be used for communicating between two devices may be used. The PTU may utilize for example, the category of the PRU while being located in proximity to the charging area to set a maximum charging value such that the current does not increase to a point where the human exposure to RF waves does not exceed imposed SAR values.

At block 558, the PRU may receive information from the PTU about the maximum charging current. In some embodiments, the PRU may send a charging request to the PTU requesting to be charged. It is understood that the above are only examples and that other communications between the PRU and PTU may be employed in order to exchange device information that may assist the PTU for setting the maximum charging current.

FIG. 6 shows a functional diagram of an exemplary communication station 600 in accordance with some embodiments. In one embodiment, FIG. 6 illustrates a functional block diagram of a communication station that may be suitable for use as an PTU 102 (FIG. 1) or a user device 120 (FIG. 1) in accordance with some embodiments. The communication station 600 may also be suitable for use as a handheld device, mobile device, cellular telephone, smartphone, tablet, netbook, wireless terminal, laptop computer, wearable computer device, femtocell, High Data Rate (HDR) subscriber station, access point, access terminal, or other personal communication system (PCS) device.

The communication station 600 may include communications circuitry 602 and a transceiver 610 for transmitting and receiving signals to and from other communication stations using one or more antennas 601. The communications circuitry 602 may include circuitry that can operate the physical layer communications and/or medium access control (MAC) communications for controlling access to the wireless medium, and/or any other communications layers for transmitting and receiving signals. The communication station 600 may also include processing circuitry 606 and memory 608 arranged to perform the operations described herein. In some embodiments, the communications circuitry 602 and the processing circuitry 606 may be configured to perform operations detailed in FIGS. 2-5.

In accordance with some embodiments, the communications circuitry 602 may be arranged to contend for a wireless medium and configure frames or packets for communicating over the wireless medium. The communications circuitry 602 may be arranged to transmit and receive signals. The communications circuitry 602 may also include circuitry for modulation/demodulation, upconversion/downconversion, filtering, amplification, etc. In some embodiments, the processing circuitry 606 of the communication station 600 may include one or more processors. In other embodiments, two or more antennas 601 may be coupled to the communications circuitry 602 arranged for sending and receiving signals. The memory 608 may store information for configuring the processing circuitry 606 to perform operations for configuring and transmitting message frames and performing the various operations described herein. The memory 608 may include any type of memory, including non-transitory memory, for storing information in a form readable by a machine (e.g., a computer). For example, the memory 608 may include a computer-readable storage device may, read-only memory (ROM), random-access memory (RAM), magnetic disk storage media, optical storage media, flash-memory devices and other storage devices and media.

In some embodiments, the communication station 600 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 600 may include one or more antennas 601. The antennas 601 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 600 may include one or more of a keyboard, a display, a non-volatile memory port, multiple antennas, a graphics processor, an application processor, speakers, and other mobile device elements. The display may be an LCD screen including a touch screen.

Although the communication station 600 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 600 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 600 may include one or more processors and may be configured with instructions stored on a computer-readable storage device memory.

FIG. 7 illustrates a block diagram of an example of a machine 700 or system upon which any one or more of the techniques (e.g., methodologies) discussed herein may be performed. In other embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environments. The machine 700 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a power management device 732, a graphics display device 710, an alphanumeric input device 712 (e.g., a keyboard), and a user interface (UI) navigation device 714 (e.g., a mouse). In an example, the graphics display device 710, alphanumeric input device 712, and UI navigation device 714 may be a touch screen display. The machine 700 may additionally include a storage device (i.e., drive unit) 716, a signal generation device 718 (e.g., a speaker), a maximum coil current limit device 719, a network interface device/transceiver 720 coupled to antenna(s) 730, and one or more sensors 728, such as a global positioning system (GPS) sensor, compass, accelerometer, or other sensor. The machine 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.)).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the machine 700. In an example, one or any combination of the hardware processor 702, the main memory 704, the static memory 706, or the storage device 716 may constitute machine-readable media.

The maximum coil current limit device 719 may be carry out or perform any of the operations and processes (e.g., processes 500 and 550) described and shown above. For example, the maximum coil current limit device 719 may be configured to identify a user device capable of being wirelessly charged. The maximum coil current limit device 719 may determine the category of a user device and set the max current limit (e.g., ITX_MAX) to a maximum limit based at least in part on the category of the user device. The maximum coil current limit for conformance to RF exposure guidelines may be set dynamically based on the PRU device category information, with the goal of mitigating SAR regulatory compliance issues for high power, larger active area PTUs At the maximum coil current, to avoid an RF exposure condition that may exceed the SAR. PRU devices may communicate their category information (such as RIT 3-1, RIT 3-2, RIT 4-1, RIT 4-2, RIT 5-1) to the PTU through Bluetooth or an appropriate communication control channel enabled via Wi-Fi, GSM, NFC, or the like. The category information communicated may enable the PTU to load the coil with the correspondingly adequate ITX_MAX current.

While the machine-readable medium 722 is illustrated as a single medium, the term “machine-readable medium” may include a single medium or multiple media (e.g., a centralized or distributed database, and/or associated caches and servers) configured to store the one or more instructions 724.

Certain embodiments may be implemented in one or a combination of hardware, firmware, and software. Other embodiments may also be implemented as instructions stored on a computer-readable storage device, which may be read and executed by at least one processor to perform the operations described herein. The instructions may be in any suitable form, such as but not limited to source code, compiled code, interpreted code, executable code, static code, dynamic code, and the like. A computer-readable storage device or medium may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the machine 700 may include one or more processors and may be configured with instructions stored on a computer-readable storage device memory.

The term “machine-readable medium” may include any medium that is capable of storing, encoding, or carrying instructions for execution by the machine 700 and that cause the machine 700 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network 726. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700 and includes digital or analog communications signals or other intangible media to facilitate communication of such software. The operations and processes (e.g., processes 500 and 550) described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device”, “user device”, “communication station”, “station”, “handheld device”, “mobile device”, “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

In example embodiments of the disclosure, there may be a device. The device may include at least one memory that stores computer-executable instructions; and at least one processor of the one or more processors configured to access the at least one memory, wherein the at least one processor of the one or more processors may be configured to execute the computer-executable instructions to determine a presence of a first device placed on a charging area of the device, the charging area including a power transmitting surface. the at least one processor of the one or more processors may be configured to execute the computer-executable instructions to establish a connection with the first device using one or more communication protocols; identify device information associated with the first device using the established connection. the at least one processor of the one or more processors may be configured to execute the computer-executable instructions to determine a maximum charging current for the first device based at least in part on the device information.

Implementations may include one or more of the following features. The device information may include at least in part a category of the device. The category of the device may be at least one of a low power output, medium power output, or a high power output. The one or more communication protocols include at least one of a Bluetooth low energy (BLE), near field communication (NFC), in-band modulation, or WI-FI. The instructions to establish a connection include performing a handshake procedure for exchanging identification information with the first device. The device information may include at least one of a reactance shift produced by the first device, a universally unique identifier (UUID), or a BLE medium access control (MAC) address. The at least one processor of the one or more processors may be further configured to execute the computer-executable instructions to determine, using a pressure sensor, a category of the device based at least in part on the weight of the second device on the charging area of first device. The device may further include a transceiver configured to transmit and receive wireless signals; an antenna coupled to the transceiver. The device may also include one or more processors in communication with the transceiver.

In example embodiments of the disclosure, there may be a non-transitory computer-readable medium. The non-transitory computer-readable medium may store computer-executable instructions which, when executed by a processor, cause the processor to perform operations comprising: establishing a connection between a device and a power transmitting unit (PTU) using one or more communication protocols; identifying a request for device information associated with the device; cause to send the device information to the PTU; and identify a maximum charging current based at least in part on the device information.

Implementations may include one or more of the following features. The non-transitory computer-readable medium wherein the computer-executable instructions, cause the processor to further perform operations may include operations to cause to send a request for charging the device. The device information may include at least in part a category of the device. The category of the device is at least one of a low power output, medium power output, or a high power output. The one or more communication protocols include at least one of a Bluetooth low energy (BLE), near field communication (NFC), in-band modulation, or Wi-Fi. The non-transitory computer-readable medium wherein the operations to establish a connection may include performing a handshake procedure for exchanging identification information between the device and the PTU. The non-transitory computer-readable medium wherein the device information may include at least one of a reactance shift produced by the PTU, a universally unique identifier (UUID), or a BLE medium access control (MAC) address.

In example embodiments of the disclosure, there may be a method. The method may include determining a presence of a second device placed on a charging area of a first device, the charging area including a power transmitting surface; establishing a connection with the second device using one or more communication protocols; identifying device information associated with the second device using the established connection; and determining a maximum charging current for the second device based at least in part on the device information.

Implementations may include one or more of the following features. The device information may include at least in part a category of the device. The category of the device is at least one of a low power output, medium power output, or a high power output. The one or more communication protocols include at least one of a Bluetooth low energy (BLE), near field communication (NFC), in-band modulation, or Wi-Fi. Establishing a connection may include performing a handshake procedure for exchanging identification information with the first device. The method may further include determining using a pressure sensor, a category of the device based at least in part on the weight of the second device on the charging area of first device.

In example embodiments of the disclosure, there may be a wireless communication apparatus. The wireless communication apparatus may include means for causing the establishment of a connection with a device with a power transmitting unit (PTU) using one or more communication protocols. The wireless communication apparatus may include means for identifying a request for device information associated with the device. The wireless communication apparatus may include means for causing to send the device information to the PTU. The wireless communication apparatus may include means for identifying a maximum charging current based at least in part on the device information.

Implementations may include one or more of the following features. The wireless communication apparatus may further include means for causing to send a request for charging the device. The device information may include at least in part a category of the device. The category of the device is at least one of a low power output, medium power output, or a high power output. The one or more communication protocols may include at least one of a Bluetooth Low Energy (BLE), Near Field Communication (NFC), in-band modulation, or Wi-Fi. The means for causing the establishment of a connection include performing a handshake procedure for exchanging identification information with the PTU. The device information may include at least one of a reactance shift produced by the PTU, a Universally Unique Identifier (UUID), or a BLE medium access control (MAC) address.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, comprising:
at least one memory that stores computer-executable instructions; and
at least one processor of one or more processors configured to access the at least one memory, wherein the at least one processor of the one or more processors is configured to execute the computer-executable instructions to:
determine a presence of a first device of one or more devices placed on a charging area of the device, the charging area including a power transmitting surface;
establish a connection with the first device using one or more communication protocols;
identify device information associated with the first device using the established connection; and
determine a maximum charging current of the first device based at least in part on the device information.

2. The device of claim 1, wherein the device information includes at least in part a category of the device.

3. The device of claim 1, wherein the at least one processor of the one or more processors is further configured to execute the computer-executable instructions to:
determine a first category of the first device;
determine a second category of a second device of the one or more devices;
determine a first maximum charging current associated with the first device;
determine a second maximum charging current associated with the second device; and
determine that the first maximum charging current is lower than the second maximum charging current when the first category is lower than the second category.

4. The device of claim 2, wherein the category of the device is at least one of a low power output, medium power output, or a high power output.

5. The device of claim 1, wherein the one or more communication protocols include at least one of a Bluetooth Low Energy (BLE), Near Field Communication (NFC), in-band modulation, or Wi-Fi.

6. The device of claim 3, wherein the at least one processor of the one or more processors is further configured to execute the computer-executable instructions to determining, using a pressure sensor, a category of the device based at least in part on a weight of the second device on the charging area of first device.

7. The device of claim 1, further comprising:
a transceiver configured to transmit and receive wireless signals;
an antenna coupled to the transceiver; and
one or more processors in communication with the transceiver.

8. A non-transitory computer-readable medium storing computer-executable instructions which, when executed by a processor, cause the processor to perform operations comprising:
causing an establishment of a connection with a device with a power transmitting unit (PTU) using one or more communication protocols;
identifying a request for device information associated with the device;
causing to send the device information to the PTU; and
identifying a maximum charging current based at least in part on the device information.

9. The non-transitory computer-readable medium of claim 8, wherein the computer-executable instructions, cause the processor to further perform operations comprising causing to send a request for charging the device.

10. The non-transitory computer-readable medium of claim 8, wherein the device information includes at least in part a category of the device.

11. The non-transitory computer-readable medium of claim 10, wherein the category of the device is at least one of a low power output, medium power output, or a high power output.

12. The non-transitory computer-readable medium of claim 10, wherein the one or more communication protocols include at least one of a Bluetooth Low Energy (BLE), Near Field Communication (NFC), in-band modulation, or Wi-Fi.

13. The non-transitory computer-readable medium of claim 10, wherein the operations to establish a connection include performing a handshake procedure for exchanging identification information with the PTU.

14. The non-transitory computer-readable medium of claim 8, wherein the device information includes at least one of a reactance shift produced by the PTU, a Universally Unique Identifier (UUID), or a BLE medium access control (MAC) address.

15. A method comprising:
determining, by a first device, a presence of a second device placed on a charging area of the first device, the charging area including a power transmitting surface;
establishing a connection with the second device using one or more communication protocols;
identifying device information associated with the second device using the established connection; and
determining a maximum charging current for the second device based at least in part on the device information.

16. The method of claim 15, wherein the device information includes at least in part a category of the device.

17. The method of claim 16, wherein the category of the device is at least one of a low power output, medium power output, or a high power output.

18. The method of claim 15, wherein the one or more communication protocols include at least one of a Bluetooth Low Energy (BLE), Near Field Communication (NFC), in-band modulation, or Wi-Fi.

19. The method of claim 15, wherein establishing a connection includes performing a handshake procedure for exchanging identification information with the first device.

20. The method of claim 15, further including determining, using a pressure sensor, a category of the device based at least in part on a weight of the second device on the charging area of first device.
